(19) United States
(12) Patent Application Publication
(10) Pub. No.: US 2004/0187218 A1
(43) Pub. Date: Sep. 30, 2004

(54) Stapling assembly for sheet materials

(76) Inventor: Jen Chang Chen, Taichung (TW)

Correspondence Address: Jen Chang Chen, P.O. Box 63-99, Taichung, 406, TW

(21) Appl. No.: 10/402,801

(22) Filed: Mar. 26, 2003

(51) Int. Cl. B26B 11/00

(52) U.S. Cl. 7/158

(57) ABSTRACT

An automatic stapling assembly includes a stapling device disposed in a housing to staple edge portions of sheet materials to be stapled, a casing disposed in the housing and having a channel to receive a tape and the edge portions of sheet materials, a pressing device includes a pair of rollers to force the tape onto the edge portions of sheet materials. A cutting device includes a pair of cutter blades to cut the tape off the edge portions of sheet materials after the edge portions of sheet materials have been stapled together by the stapling device and bound together by the tape.

### BACKGROUND OF THE INVENTION

1. Field of the Invention

The present invention relates to a stapling assembly, and more particularly to an automatic stapling assembly for stapling sheet materials.

2. Description of the Prior Art

Various kinds of typical stapling devices have been developed and provided for stapling sheet materials. However, normally, the sheet materials include only either of the end portions or the middle portions thereof that may be stapled or secured together by the staples. The other portions of the sheet materials that have not been stapled or secured together by the staples may not be stably retained or secured together, and may be easily become loose.

In addition to the staples, the edge portion of the sheet materials that has been stapled or secured with the staples by the typical stapling devices may have to be further secured together with tapes, or envelopes, or the like manually. However, it is inconvenient and it takes much time for the users to staple the side or the edge portions of the sheet materials together, and to further attach the tapes onto the edge portion of the sheet materials.

The present invention has arisen to mitigate and/or obviate the afore-described disadvantages of the conventional stapling devices.

### SUMMARY OF THE INVENTION

The primary objective of the present invention is to provide an automatic stapling assembly for automatically stapling sheet materials, and for taping the sheet materials simultaneously.

In accordance with one aspect of the invention, there is provided an automatic stapling assembly comprising a housing including a slot formed therein to receive edge portions of sheet materials to be stapled together, a stapling device disposed in the housing, to staple the edge portions of the sheet materials together, a casing disposed in the housing, and including a channel formed therein to receive a tape, and to receive the edge portions of sheet materials, to allow the tape to engage onto the edge portions of sheet materials, a pressing device disposed in the housing, and including a pair of rollers to receive the tape and the edge portions of sheet materials, and to force the tape onto the edge portions of sheet materials, and a cutting device disposed in the housing, and including a pair of cutter blades to cut the tape off the edge portions of sheet materials.

The channel of the casing includes a first end, and a second end, the second end of the channel of the casing is located close to the rollers and includes a height less than that of the first end thereof. The housing includes a pulley rotatably disposed therein, to support the tape, the first end of the channel of the casing is located close to the pulley to receive the tape.

The pressing device includes a spindle, a gear and a first roller of the rollers secured on the spindle, a shaft slid ably received in the housing and parallel to the spindle, and a pinion and a second roller of the rollers secured on the shaft, the pinion is engaged with the gear, and means for rotating the spindle to drive the shaft and the rollers.

The rotating means includes a motor disposed in the housing, and coupled to the spindle. The housing includes a receptacle having at least one groove formed therein to slide ably receive the shaft.

A spring device may further be provided for biasing the shaft toward the spindle, to bias the rollers toward each other, and thus to press the edge portions of the sheet materials by the rollers. The pressing device includes a detecting device to detect whether the edge portions of sheet materials have been moved through the rollers or not.

The cutter blades of the cutting device includes a stationary cutter blade disposed in the housing, and a movable cutter blade, and the cutting device includes a driving member coupled to the movable cutter blade, to move the movable cutter blade toward the stationary cutter blade. The cutting device includes a detecting device to detect whether the edge portions of sheet materials have been moved through the edge portions of the sheet materials.

Further objectives and advantages of the present invention will become apparent from a careful reading of the detailed description provided herein below, with appropriate reference to the accompanying drawings.

### BRIEF DESCRIPTION OF THE DRAWINGS

FIG. 1 is a perspective view of an automatic stapling assembly in accordance with the present invention, in which a portion or a cover of the automatic stapling assembly has been removed to show the inner structure of the automatic stapling assembly;

FIG. 2 is a partial perspective view of the automatic stapling assembly, illustrating the tape pressing device of the stapling assembly; and

FIG. 3 is another partial perspective view of the automatic stapling assembly, illustrating the cutting device of the stapling assembly.

### DETAILED DESCRIPTION OF THE PREFERRED EMBODIMENT

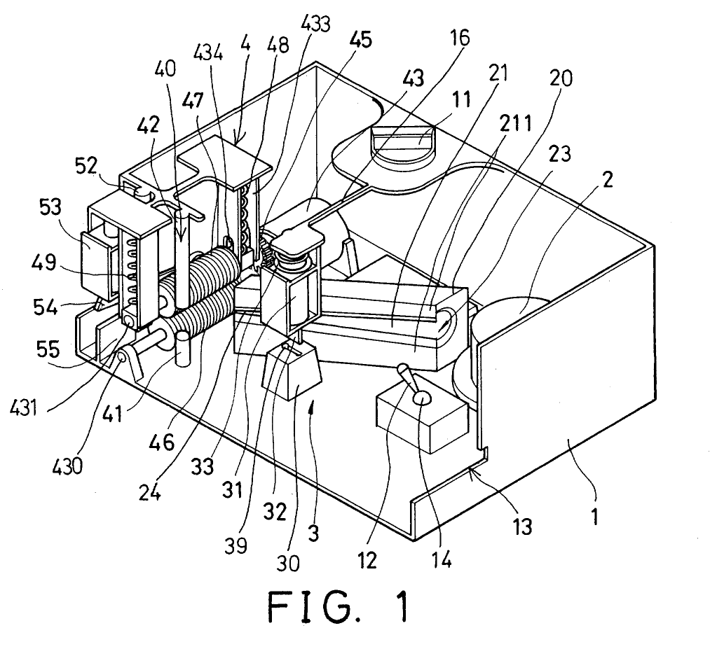

Referring to the drawings, and initially to FIG. 1, an automatic stapling assembly in accordance with the present invention comprises a housing 1 including a slot 13 formed therein, such as formed in the front portion thereof, to receive the sheet materials that is to be secured or stapled or bound together by the stapling assembly.

A pulley 2 or the like is rotatably supported in the housing 1, a roll of tape (not shown) nay be engaged around and support on the pulley 2, and disposed beside or behind the slot 13 of the housing 1, for being attached or engaged onto the edge portions of the sheet materials.

A casing 20 is disposed in the housing 1, and includes a channel 21 formed therein and defined by a pair of flaps 211. The casing 20 includes one end 23 located closer to the pulley 2 to receive the tape from the pulley 2, and the other end 24 located distal to the pulley 2.

The channel 21 of the casing 20 includes a diameter of width or depth or height gradually reduced from the one end 23 thereof toward the other end 24 thereof, or the gap between the flaps 211 is gradually reduced from the one end 23 of the casing 20 toward the other end 24 of the casing 20, for forcing the tape onto the edge portions of the sheet materials that are engaged into the slot 13 of the housing 1.

A bar 12 has a lower portion rotatably secured to the housing 1 with a ball joint 14, for allowing the bar 12 to be rotated relative to the housing 1. The bar 12 is disposed close to or between the slot 13 of the housing 1 and the channel 21 of the casing 20, for being moved by the sheet materials that are engaged into the slot 13 of the housing 1.

A stapling device 3 is disposed in the housing 1, and includes a base 30 having a slot 39 formed therein to receive the staple (not shown), and includes a driving member 31, such as an electromagnetic driving member 31 supported on an arm 16 of the housing 1, and having a striker 32 attached to the bottom thereof, and disposed above the slot 39 of the base 30, for forcing the staple through the edge portions of the sheet materials and/or into the slot 39 of the base 30.

A spring member 33 may further be provided and engaged between the arm 16 and the electromagnetic driving member 31, for such as biasing the striker 32 onto the edge portions of the sheet materials. The housing 1 may further include an adjusting device 11 for adjusting the arm 16 to adjust the distance between the striker 32 and the edge portions of the sheet materials, for example. The adjusting device 11 is not related to the present invention and will not be described in further details.

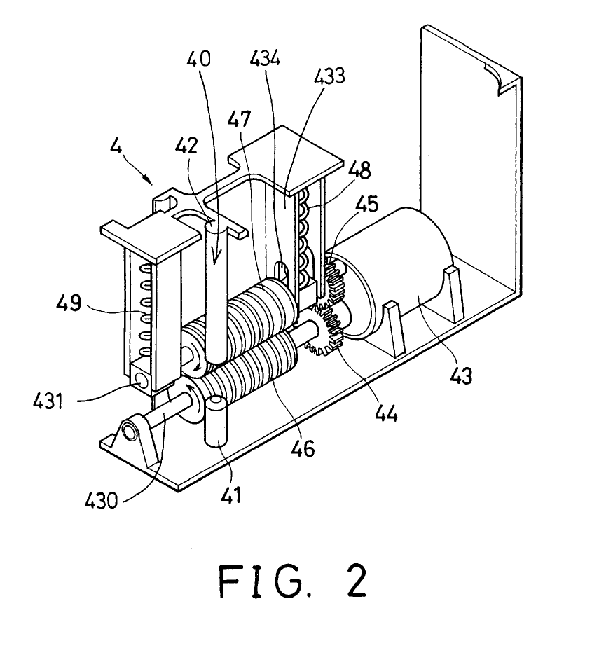

As shown in FIGS. 1 and 2, a tape pressing device 4 is provided and disposed in the housing 1, and located close to the other end 24 of the casing 20, for pressing the tape onto the edge portions of the sheet materials, and includes a detecting device 40 having such as a light emitter and a light receiver 41, 42, and disposed beside the other end 24 of the casing 20, to detect whether the edge portions of the sheet materials have been moved through the channel 21 of the casing 20 or not.

The tape pressing device 4 further includes a driving device 43, such as a motor 43 disposed in the housing 1, a spindle 430 rotatably supported in the housing 1 and secured to the motor 43, for being rotated or driven by the motor 43. A gear 44 and a knurled pressing roller 46 are secured on the spindle 430 and rotated in concert with the spindle 430 and may thus also be rotated or driven by the motor 43.

A shaft 431 is rotatably and slidably supported in a receptacle 433 of the housing 1, such as slidably received in one or more grooves 434 of the receptacle 433, and disposed parallel to the spindle 430. A pinion 45 and another pressing roller 47 are secured on the shaft 431 and rotated in concert with the shaft 431. The pinion 45 and the gear 44 include a number of teeth arranged to be engaged or meshed with each other when the shaft 431 is moved toward or away from the spindle 430 for a predetermined distance.

One or more spring members 48, 49 may further be provided and engaged onto the shaft 431, or biased between the receptacle 433 or the housing 1 and the shaft 431, in order to bias the roller 47 toward the other roller 46, and for allowing the rollers 46, 47 to press the tape onto the edge portions of the sheet materials. The pinion 45 may also be biased to engage with the gear 44, for allowing the shaft 431 to be rotated and driven by the motor 43.

In operation, the driving member 31 of the stapling device 3 may be controlled to staple the edge portions of the sheet materials one or more times while the edge portions of the sheet materials move through the channel 21 of the casing 20. The tape may then be engaged and pressed onto the edge portions of the sheet materials to shield the staples by the rollers 46, 47 after the edge portions of the sheet materials have been stapled together.

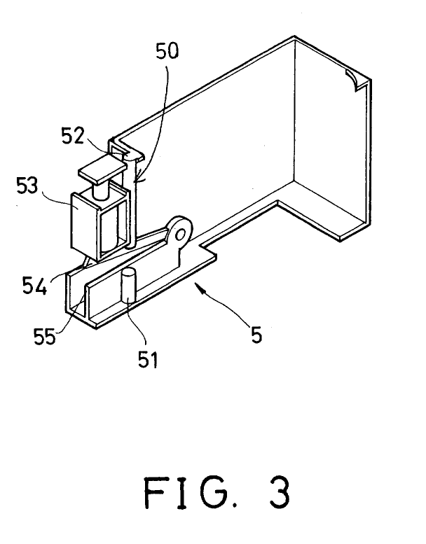

As shown in FIGS. 1 and 3, a cutting device 5 is provided and disposed in the housing 1 for cutting the tape of the edge portions of the sheet materials, and includes a detecting device 50 having such as a light emitter and a light receiver 51, 52, and disposed beside the rollers 46, 47, to detect whether the edge portions of the sheet materials have been moved through the rollers 46, 47 or not.

Another driving member 53, such as an electro-magnetic driving member 53 is supported on such as the housing 1, and a movable cutter blade 54 attached to the bottom of the driving member 53, and a stationary cutter blade 55 disposed below the movable cutter blade 54, to cut the tape of the edge portions of the sheet materials, after the edge portions of the sheet materials have been moved out through the detecting device 50.

In operation, the edge portions of the sheet materials may be engaged into or through the slot 13 of the housing 1, and may then be moved through the stapling device 3, so as to have one or more portions thereof stapled together by the stapling device 3. The edge portions of the sheet materials may then be moved through the channel 21 of the casing 20, such as the narrower end 24 of the channel 21 of the casing 20, for allowing the tape to be engaged onto the edge portions of the sheet materials.

The tape may then be engaged and pressed onto the edge portions of the sheet materials to shield the staples by the rollers 46, 47 after the edge portions of the sheet materials have been stapled together by the stapling device 3. The tape may then be cut by the cutting device 5 after the edge portions of the sheet materials have been moved out through the cutter device 5. The edge portions of the sheet materials may thus be easily and quickly stapled together and bound together by the tape.

A staple supporting and/or supplying device (not shown) may further be provided and disposed close to the stapling device 3, for supplying the staples into or through the stapling device 3, and for allowing the staples to be stricken into the edge portions of the sheet materials by the striker 32. An integrated circuit or a processor device (not shown) may further be provided to control or to operate the stapling device 3, the tape pressing device 4 and the cutting device 5.

Accordingly, the stapling assembly in accordance with the present invention may be used for automatically stapling the sheet materials together, and for taping the edge portions of the sheet materials simultaneously, in order to shield the staples.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. An automatic stapling assembly comprising:
a housing including a slot formed therein to receive edge portions of sheet materials to be stapled together,
a stapling device disposed in said housing, to staple the edge portions of the sheet materials together,
a casing disposed in said housing, and including a channel formed therein to receive a tape, and to receive the edge portions of sheet materials, to allow the tape to engage onto the edge portions of sheet materials,
a pressing device disposed in said housing, and including a pair of rollers to receive the tape and the edge portions of sheet materials, and to force the tape onto the edge portions of sheet materials, and
a cutting device disposed in the housing, and including a pair of cutter blades to cut the tape off the edge portions of sheet materials.

2. The stapling assembly as claimed in claim 1, wherein said channel of said casing includes a first end, and a second end, said second end of said channel of said casing is located close to said rollers and includes a height less than that of said first end thereof.

3. The stapling assembly as claimed in claim 2, wherein said housing includes a pulley rotatably disposed therein, to support the tape, said first end of said channel of said casing is located close to said pulley to receive the tape.

4. The stapling assembly as claimed in claim 1, wherein said pressing device includes a spindle, a gear and a first roller of said rollers secured on said spindle, a shaft slidably received in said housing and parallel to said spindle, and a pinion and a second roller of said rollers secured on said shaft, said pinion is engaged with said gear, and means for rotating said spindle to drive said shaft.

5. The stapling assembly as claimed in claim 4, wherein said rotating means includes a motor disposed in said housing, and coupled to said spindle.

6. The stapling assembly as claimed in claim 4, wherein said housing includes a receptacle having at least one groove formed therein to slidably receive said shaft.

7. The stapling assembly as claimed in claim 4 further comprising means for biasing said shaft toward said spindle, to bias said rollers toward each other.

8. The stapling assembly as claimed in claim 1, wherein said pressing device includes a detecting device to detect whether the edge portions of sheet materials have been moved through said rollers or not.

9. The stapling assembly as claimed in claim 1, wherein said cutter blades of said cutting device includes a stationary cutter blade disposed in said housing, and a movable cutter blade, and said cutting device includes a driving member coupled to said movable cutter blade, to move said movable cutter blade toward said stationary cutter blade.

10. The stapling assembly as claimed in claim 1, wherein said cutting device includes a detecting device to detect whether the edge portions of sheet materials have been moved through said cutter blades or not.
